(19) United States
(12) Patent Application Publication
(10) Pub. No.: US 2009/0119223 A1
(43) Pub. Date: May 7, 2009

(54) METHOD AND A SYSTEM FOR FACILITATING AN ELECTRONIC BARTER TRANSACTION BETWEEN BARTERING PARTIES

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/933,560

(22) Filed: Nov. 1, 2007

(51) Int. Cl. G06Q 30/00

(52) U.S. Cl. 705/80

(57) ABSTRACT

There is provided a method for facilitating an electronic barter transaction between bartering parties, the method comprising (1) initiating a barter request associated with a first bartering party, said barter request comprising a first data identifying a first set of items to be provided within said barter transaction, said first set of items comprising at least one item, (2) receiving a first barter offer associated with a second bartering party, said first barter offer comprising an offer to acquire said first set of items in exchange of a second set of items, said second set of items comprising at least one item, (3) accepting or refusing said first barter offer, and (4) concluding or declining said electronic barter transaction between said first bartering party and said second bartering party as a function of said accepting or refusing, said concluding or said declining being carried out without negotiation between said parties in connection with said transaction. There is also provided a system for facilitating an electronic barter transaction between bartering parties.

### FIELD OF THE INVENTION

The present invention relates generally to the field of commercial transactions, and more specifically to a method and a system for facilitating an electronic barter transaction between bartering parties.

### BACKGROUND OF THE INVENTION

Electronic bartering of items over a network is a wide practice in our days. Traditionally, an initiating bartering party willing to exchange a given item would list on the network a description of the item to provide as well as a description of the item to receive in exchange. The initiating bartering party would then wait to receive a notification of a potential bartering party inviting to negotiate a prospective barter transaction. This process of negotiation between the bartering parties implies exchange of several messages therebetween before concluding the barter transaction. This exchange of several messages between the bartering parties is time consuming.

### SUMMARY OF THE INVENTION

It is therefore an object of the present invention to provide methods and apparatus for facilitating a bartering transaction between bartering parties over a network that overcome the above drawbacks.

As a first aspect of the invention there is provided a method for facilitating an electronic barter transaction between bartering parties, the method comprising:
initiating a barter request associated with a first bartering party, said barter request comprising a first data identifying a first set of items to be provided within said barter transaction, said first set of items comprising at least one item;
receiving a first barter offer associated with a second bartering party, said first barter offer comprising an offer to acquire said first set of items in exchange of a second set of items, said second set of items comprising at least one item;
accepting or refusing said first barter offer; and
concluding or declining said barter transaction between said first bartering party and said second bartering party as a function of said accepting or refusing, where said concluding or declining is carried out without negotiation between said parties.

The barter request preferably further comprises a second data identifying at least one set of wanted items among which said second set of items may be selected.

The barter request preferably further comprises a time period within which said first barter offer may be received, and said accepting or refusing said first barter offer can be carried out as a function of time of reception of said first barter offer with respect to said time period.

The method preferably further comprises receiving a second barter offer associated with a second bartering party, wherein said accepting or refusing said first barter offer can be carried out as a function of time of reception of said first barter offer with respect to time of reception of said second barter offer.

Each one of said at least one set of wanted items is preferably associated with a predefined order of preference.

The method preferably further comprises receiving a second barter offer associated with a second bartering party, said second barter offer comprising an offer to acquire said first set of items in exchange of a third set of items, said first and second sets of items preferably being selected among said at least one set of wanted items and being associated respectively with a first and a second predefined order of preferences, and said accepting or refusing said first barter offer is preferably carried out as a function of comparison between said first and second predefined order of preferences.

The first data can consist of a literal description identifying said first set of items. The second data can also consist of a literal description identifying said at least one set of wanted items.

Preferably, the method is essentially carried out through a mediator having a mediator server.

The mediator server is preferably connected to a network comprising the Internet and comprises a mediator Web site, and, preferably, said method is essentially carried out through said mediator's Web site.

The initiating a barter request preferably comprises listing said barter request on said mediator's Web site.

The listing said barter request can be carried out using a browser stored on said mediator server. The listing said barter request can be also carried out using a document having a document format adapted to be interpreted using an end-user computer software. The document format can be HTML. The document format can be also XML.

The receiving a barter offer preferably comprises posting said barter offer to said mediator's Web site. The posting said barter request can be carried out using a browser stored on said mediator server. The posting said barter request can be also carried out using a document having a document format adapted to be interpreted using an end-user computer software. The document format can be HTML. The document format can also be XML.

The accepting or refusing said first barter offer can be carried out automatically by said mediator server using a computer program running thereon. The concluding or declining said transaction can also be carried out automatically by said mediator server using a computer program running thereon.

The method preferably further comprises comparing said barter request to a list including a plurality of barter requests stored on said mediator server, and determining prospective bartering parties associated with at least a part of said stored barter requests.

The method preferably further comprises notifying said prospective bartering parties of said barter request.

As a second aspect of the invention, there is provided a system for facilitating an electronic barter transaction between bartering parties, the system comprising:
a barter request initiating module for initiating a barter request associated with a first bartering party, said barter request comprising a first data identifying a first set of items to be provided within said barter transaction, said first set of items comprising at least one item;
a barter offer receiving module for receiving a first barter offer associated with a second bartering party, said first barter offer comprising an offer to acquire said first set of items in exchange of a second set of items, said second set of items comprising at least one item;
a barter offer responding module for accepting or refusing said first barter offer; and
a transaction concluding module for concluding or declining said barter transaction between said first bartering party and said second bartering party as a function of said accepting or refusing, where said concluding or said declining is carried out without negotiation between said parties.

Preferably, the system is essentially provided by a mediator server adapted to be connected to a network.

The system preferably further comprises a mediator Web site stored on said mediator server.

The barter request initiating module preferably comprises a first user interface for listing said barter request on said mediator's Web site. The first user interface can consist of a browser stored on said mediator server. The first user interface can also consist of a document having a document format adapted to be interpreted using an end-user computer software. The document format can be HTML. The document format can also be XML.

Preferably, the barter offer responding module is programmed for automatically accepting or refusing said barter transaction as a function of predefined barter offer selection criteria stored on said mediator server. Preferably, the transaction concluding module is programmed for automatically concluding or declining said barter transaction as a function of said accepting or refusing.

The system preferably further comprises a comparing module for comparing said barter request to a list including multiple barter requests stored on said mediator server and for determining prospective bartering parties associated with at least a part of said barter requests. The system preferably further comprises a notifying module for notifying said prospective bartering parties of said barter request.

As a further aspect of the invention, there is provided a computer program including embedded information embedded therein by the above described method.

The computer program is preferably embodied as a computer readable medium having stored thereon the computer program.

### BRIEF DESCRIPTION OF THE DRAWINGS

Further features and advantages of the present invention will become apparent from the following detailed description, taken in combination with the appended drawings, in which:

FIG. 1 is a flow chart showing an embodiment of a method for facilitating a barter transaction between bartering parties over a network; and

FIG. 2 is a block diagram showing an embodiment of a system for facilitating a barter transaction between bartering parties over a network.

### DETAILED DESCRIPTION OF THE INVENTION

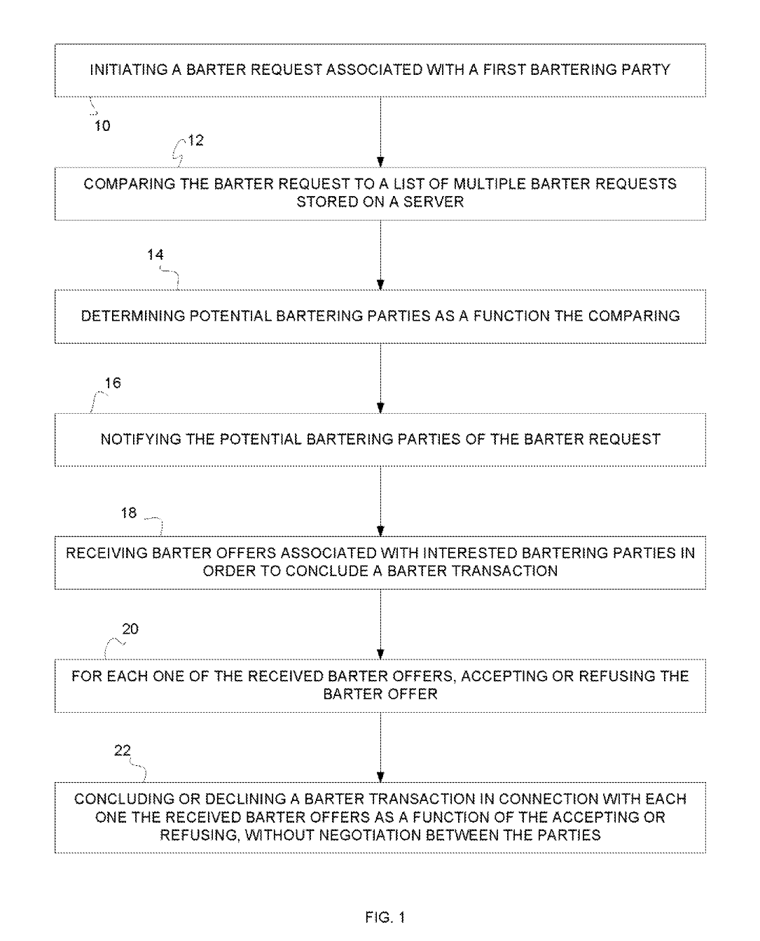

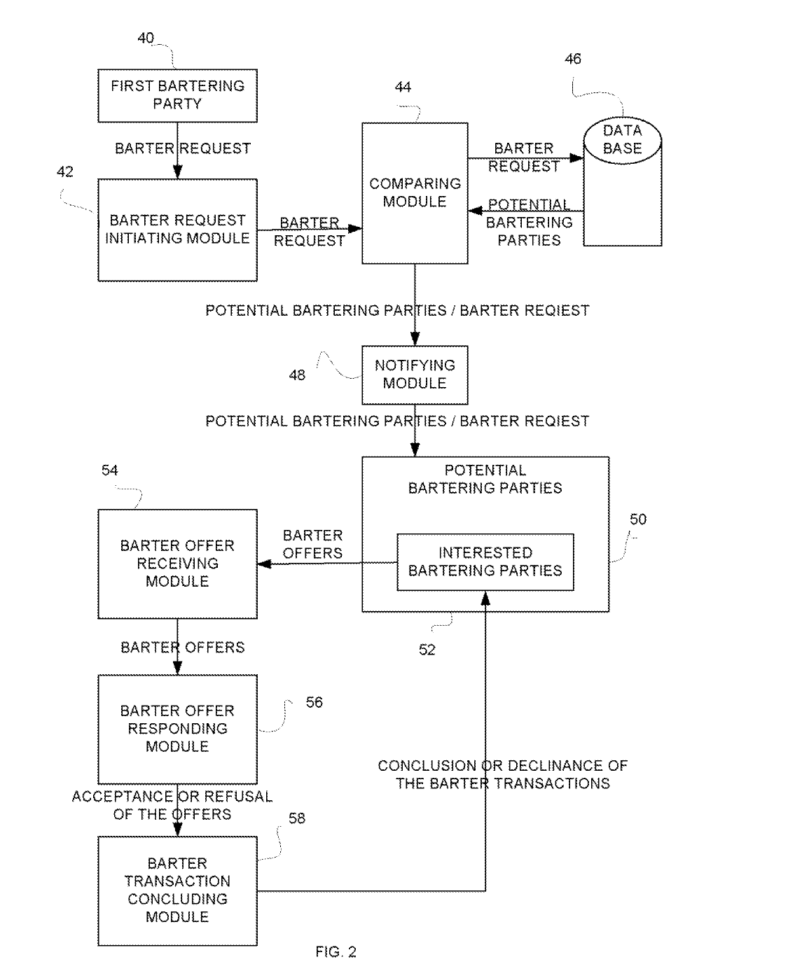

Referring to FIG. 1 and FIG. 2, there is respectively provided a method and a system for facilitating a barter transaction between bartering parties over a network. First, a first bartering party 40 initiates a barter request 10 through a barter request initiating module 42 connected to a mediator Web site. The barter request comprises an identification of a first set of items to be provided within said barter transaction. The identification can be a literal text, an image, a combination thereof, or any other form of item identification.

The first option for the first bartering party 40 is to invite potential bartering parties to propose by themselves a second set of items different from the first set of items that they would offer to exchange against the first set of items identified by the first bartering party. In such a case, the first bartering party 40 does not need to specify at least one set of wanted items in the barter request.

The second option for the first bartering party 40 is to identify at least one set of wanted items that he is willing to accept in exchange of the set of items he wants to provide. In this case, the first bartering party 40 should identify in his barter request these at least one set of wanted items. The first bartering party 40 can also specify in his request an order of preference among these at least one sets of wanted items, in such a way that between a plurality of received barter offers, the barter offer comprising a wanted set of items with the highest order of preference will be selected.

The initiating process of the barter request implies also listing the barter request on the mediator's Web site.

The barter request initiating module 42 can then send the barter request to a comparing module 44 connected thereto. The comparing module 44 is also connected to a mediator database 46 for comparing the barter request to a list of multiple barter requests stored thereon 12.

More precisely, the comparing module 44 compares the first set of items identified in the first barter request with the set of items identified in the other barter requests stored in the database 46, and determines potential bartering parties as a function of the comparing 14. In fact, the determined potential parties are those whose sets of items stored in the database 46 match with at least one among the set of wanted items identified by the first bartering party 40.

The mediator database 46 sends back a list of the potential bartering parties to the comparing module 44. The comparing module 44 sends the list of the determined potential parties and the barter request to a notifying module 48. Then, the notifying module 48 notifies the potential bartering parties 50 of the barter request 16.

After the notification process, the interested bartering parties 52 among the notified potential bartering parties 50 send barter offers to a barter offer receiving module 54. The barter offer receiving module 54 receives the barter offers associated with the interested bartering parties in order to conclude a barter transaction 18.

Each one of the barter offers comprise an offer to acquire the first set of items in exchange of a given set of items. The description of the given set of items can be either stored on the mediator server or integrated in the barter offer. If the barter request identifies at least one set of wanted items, the given set of items must be selected among these at least one set of wanted items.

The barter offer receiving module 54 transmits the barter offers to a barter offer responding module 56 connected thereto. The barter offer responding module 56 is adapted to accept or refuse each one of the barter offers.

The acceptance or refusal can be carried out manually by the first bartering party. However, the acceptance or refusal can also be carried out automatically using a computer program running on the mediator server as a function of offer selection criteria predefined by the first bartering party.

For instance, if the first bartering party defines the “first offer wins” rule among the offer selection criteria, the bartering transaction is concluded with the bartering party associated with the first barter offer received by the barter offer receiving module 54 and that respects the other predefined criteria if specified. If the first bartering party specifies in the barter request an order of preference associated with the at least one set of wanted items, the selection is carried out as a function of the predefined order of preference. More precisely, the accepted barter offer will be the one having identified a given set of items having the highest order of preference.

The barter offer responding module 56 transmits the acceptance or refusal decision to the barter transaction concluding module 58 connected thereto. The barter transaction concluding module 58 concludes or declines a barter transaction between the first bartering party and each one of the interested bartering parties associated with the barter offers as a function of the accepting or refusing of the correspondent barter offer, without negotiation between the parties 22. In fact, if the barter offer is accepted, the barter transaction is automatically concluded, and if the barter offer is refused, the transaction is automatically declined. After the reception of the batter offer, there is no exchange of messages between the bartering parties in order to negotiate the barter transaction. The barter transaction is either accepted or declined, and no other option is available.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for facilitating an electronic barter transaction between bartering parties, the method comprising:
initiating a barter request associated with a first bartering party, said barter request comprising a first data identifying a first set of items to be provided within said barter transaction, said first set of items comprising at least one item;
receiving a first barter offer associated with a second bartering party, said first barter offer comprising an offer to acquire said first set of items in exchange of a second set of items, said second set of items comprising at least one item;
accepting or refusing said first barter offer; and
concluding or declining said electronic barter transaction between said first bartering party and said second bartering party as a function of said accepting or refusing, said concluding or declining being carried out without negotiation between said parties.

2. The method as claimed in claim 1, wherein said barter request further comprises a second data identifying at least one set of wanted items among which said second set of items may be selected.

3. The method as claimed in claim 1, wherein said barter request further comprises a time period within which said first barter offer may be received, and said accepting or refusing said first barter offer is carried out as a function of time of reception of said first barter offer with respect to said time period.

4. The method as claimed in claim 1, further comprising receiving a second barter offer associated with a second bartering party, wherein said accepting or refusing said first barter offer is carried out as a function of time of reception of said first barter offer with respect to time of reception of said second barter offer.

5. The method as claimed in claim 2, wherein each one of said at least one set of wanted items is associated with a predefined order of preference.

6. The method as claimed in claim 5, said method further comprising receiving a second barter offer associated with a second bartering party, said second barter offer comprising an offer to acquire said first set of items in exchange of a third set of items, said first and second sets of items being selected among said at least one set of wanted items and being associated respectively with a first and a second predefined order of preferences, and said accepting or refusing said first barter offer is carried out as a function of comparison between said first and second predefined order of preferences.

7. The method as claimed in claim 6, wherein said first data consists of a literal description identifying said first set of items, and said second data consists of a literal description identifying said at least one set of wanted items.

8. The method as claimed in claim 1, wherein said method is essentially carried out through a mediator having a mediator server.

9. The method as claimed in claim 8, wherein said mediator server is adapted to be connected to a network comprising the Internet and comprises a mediator Web site, said method is essentially carried out through said mediator's Web site, and said initiating a barter request comprises listing said barter request on said mediator's Web site.

10. The method as claimed in claim 9, wherein said receiving a barter offer comprises posting said barter offer to said mediator's Web site.

11. The method as claimed in claim 8, wherein said accepting or refusing said first barter offer is carried out by said mediator server using a computer program running thereon.

12. The method as claimed in claim 9, wherein said concluding or declining said barter transaction is carried out by said mediator server using a computer program running thereon.

13. The method as claimed in claim 8 further comprising comparing said barter request to a list including a plurality of barter requests stored on said mediator server, and determining prospective bartering parties associated with at least a part of said stored barter requests.

14. The method as claimed in claim 13 further comprising notifying said prospective bartering parties of said barter request.

15. A system for facilitating an electronic barter transaction between bartering parties, the system comprising:
a barter request initiating module for initiating a barter request associated with a first bartering party, said barter request comprising a first data identifying a first set of items to be provided within said barter transaction, said first set of items comprising at least one item;
a barter offer receiving module for receiving a first barter offer associated with a second bartering party, said first barter offer comprising an offer to acquire said first set of items in exchange of a second set of items, said second set of items comprising at least one item;
a barter offer responding module for accepting or refusing said first barter offer; and
a transaction concluding module for concluding or declining said barter transaction between said first bartering party and said second bartering party as a function of said accepting or refusing, where said concluding or said declining is carried out without negotiation between said parties.

16. The system as claimed in claim 15, wherein said system is essentially provided by a mediator server.

17. The system as claimed in claim 16, wherein said system is adapted to be connected to a network and further comprises a mediator Web site stored on said mediator server.

18. The system as claimed in claim 17, wherein said barter request initiating module comprises a first user interface for listing said barter request on said mediator's Web site.

19. The system as claimed in claim 18, wherein said first user interface consists of a browser stored on said mediator server.

20. The system as claimed in claim 18, wherein said first user interface consists of a document having a document format adapted to be interpreted using an end-user computer software.

21. The system as claimed in claim 15, wherein said barter offer responding module is programmed for automatically accepting or refusing said first barter offer as a function of predefined barter offer selection criteria stored on said mediator server.

22. The system as claimed in claim 21, wherein said transaction concluding module is programmed for automatically concluding or declining said first barter offer as a function of said accepting or refusing said first barter offer.

23. The system as claimed in claim 15, further comprising a comparing module for comparing said barter request to a list including multiple barter requests stored on said mediator server and for determining prospective bartering parties associated with at least a part of said barter requests.

24. The system as claimed in claim 23 further comprising a notifying module for notifying said prospective bartering parties of said barter request.

25. A computer program including embedded information embedded therein by the method according to claim 15.
